(19) United States
(12) Patent Application Publication
(10) Pub. No.: US 2022/0108083 A1
(43) Pub. Date: Apr. 7, 2022

(54) Inter-Language Vector Space: Effective assessment of cross-language semantic similarity of words using word-embeddings, transformation matrices and disk based indexes.

(71) Applicants: Andrzej Zydron, High Wycombe (GB); Rafal Jaworski, Mosina (PL)

(72) Inventors: Andrzej Zydron, High Wycombe (GB); Rafal Jaworski, Mosina (PL)

(21) Appl. No.: 17/064,620

(22) Filed: Oct. 7, 2020

(51) Int. Cl. G06F 40/51; G06F 40/58; G06F 40/30; G06F 40/45

(52) U.S. Cl. CPC G06F 40/51; G06F 40/45; G06F 40/30; G06F 40/58

(57) ABSTRACT

Inter-Language Vector Space (ILVS) is a technology based on deep learning, neural networks and algebraic algorithms for supervised learning of vector transformations. The construction of the ILVS consists of three phases. The first phase uses large-scale monolingual text corpora for different languages fed to a neural network with a task of predicting the context of a given word. Internally, the neural network computes 300-dimensional vector representations (word embeddings) of all the words in the corpus using its hidden layer of 300 neurons. The second phase consists in training of transformation matrices allowing for conversion of these vectors between the languages. The last phase is building a disk-based index to store the converted word vectors in multiple languages. ILVS allows for computing the similarity of a pair of words between any two of the languages by retrieving vector representations of the words and applying algebraic functions on those vectors.

### SIMILAR SOLUTIONS ON THE MARKET/SIMILAR US PATENTS

Systran Similarity

Title: Similarity (open source software library)

Summary: Using direct neural network training to compute word similarities across languages.

Differences from AI VS:
requires pre-training on word-aligned corpora (which are not available for many languages)
makes use of part-of-speech taggers (which are not available for many languages)
calculation of the similarity requires data of considerable size to be loaded into RAM

Babylon Health experiments

Title: Aligning the fastText vectors of 78 languages

Summary: Idea of putting word embeddings into a single vector space

Differences from AI VS:
calculation of the similarity requires data of considerable size to be loaded into RAM
alignment of word vectors does not use dictionary data (which was proved to enhance the results)

U.S. Pat. No. 8,077,984

Title: Method for computing similarity between text spans using factored word sequence kernels Summary: computing similarity of whole text spans using statistical methods

Differences from AI VS:
similarity is calculated on whole text spans, not words
statistical methods are used, instead of neural networks

U.S. Pat. No. 6,161,083

Title: Example-based translation method and system which calculates word similarity degrees, a priori probability, and transformation probability to determine the best example for translation

Summary: calculating word similarity for the needs of example-based translation

Differences from AI VS:
different method of estimating similarity of words—thesaurus instead of modern big-data neural networks approach
different purpose of calculating word translation probabilities—example-based translation needs to estimate the similarity of whole sentences, not individual words

U.S. Pat. No. 10,740,570

Title: Processing noisy data and determining word similarity

Summary: Assessing word similarity based on dependency structures

Differences from AI VS:
done only in a single language at the time
uses statistical methods (frequency information)
requires in-depth linguistic analysis of the input text

### BRIEF DESCRIPTION/SUMMARY OF AI VECTOR SPACE

Inter-Language Vector Space is a technology that assists in the translation of text in digital form from a source language into a target language. Based on detailed neural network mathematical analysis of a very large corpus of source and target text Inter-Language Vector Space can calculate not only the relationship between words in the source and target languages, such as ‘Athens is to Greece as Paris is to . . . ’, but also the probability of a target word being a translation of a given source word.

### DETAILED DESCRIPTION OF HOW IT WORKS

Inter-Language Vector Space relies on an extensive neural network analysis of a large corpus of textual data using Skip-gram algorithms to predict surrounding words based on the current word [FIG. 1]. Vector Space provides probabilistic relationships between words, both semantic, e.g. king->man, queen->woman, as well as syntactic, e.g. adjective to adverb (apparent->apparently; rapid->rapidly etc.). Words are represented as vectors in the vector spaces created for their languages. Calculated mathematical similarity between the vectors corresponds to the aforementioned linguistic relationships between the words. This however only works within a single vector space, i.e. in a single language.

The described invention—Inter-Language Vector Space—is a method that allows for the normalization of vector spaces of two languages and merging them into one [FIG. 2]. This allows for the calculation of the probability that a given word in one language (referred to as the source language) is the equivalent of a given word in the target language, e.g. for an Inter-Language Vector Space based on the vector space for English and Italian calculated on a crawl of the whole Internet, the probability of ‘gatto’ being a translation of ‘cat’ is 0.696, while the probability of ‘giorno’ being a translation of ‘cat’ is 0.164. Any probability value over 0.5 is significant.

### DETAILED DESCRIPTION ON HOW IT CAN BE USED AND WHO WOULD USE IT

Inter-Language Vector Space can be used by Translation Management Systems (TMS) and Computer Assisted Translation (CAT) software during the translation of a given source language text in electronic binary form into a target language equivalent. It can be used to assist Project managers, Translators, Reviewers, Correctors, Machine Translation Post-Editors in their work on a translation project.

Inter-Language Vector Space can be used, among other, for the following purposes:

1. The automatic placement of inline elements in a target segment that is the translation of the source segment.

2. Automatically align segments for the corpus alignment for two languages

3. The automatic identification of target language nouns and noun-phrases for bilingual terminology extraction

4. The automatic identification of subsegment translations for a given source segment based on prior translations

5. The automatic assessment of the quality of machine translation

6. The automatic assessment of human translation

7. The automatic highlighting of mistranslations

8. The automatic highlighting of segments that require machine translation post-edit attention

9. Predictive typing assistance for translators when translating a given source segment

10. Assisting in the creation of a dynamic learning algorithm that learns from a translation.

11. To learn a given pattern for machine translation post-edit correction and automatically apply the same pattern for following/future segments

12. Automatic completion of fuzzy matches, where a given purporting of the target language can be worked out based on prior translations, but some words remain unaccounted for

13. Automatically working out semantic and syntactic equivalents between source and target words

14. Any other semantic/syntactic similarity usage between the source and target languages.

### DETAILED DESCRIPTION OF ITS PURPOSE

Inter-Language Vector Space can be used to assist in the translation of a source text into a target language. It can reduce the time and effort required in the translation process itself as well as helping to improve the quality and consistency of the translation itself. It can assist, among others in the following translation related functions:

1. Bilingual Corpus Alignment

An input to this process is a text in the source language and its translation in the target language. The output is a structured document where source and target sentences (referred to as segments) are aligned to each other. Such a list of segments is then ready to use as a translation memory, among others. The key operation in identifying correspondence between segments in two languages is the assessment of similarity between words in these segments. This can be done with the use of Inter-Language Vector Space.

2. Bilingual Terminology Extraction

Bilingual terminology extraction automatically creates a list of domain-specific terms with their translation from a translated text. The input for this process is a translation memory. After the terminology is extracted at the source side, the Inter-Language Vector Space helps to identify the target translation of each extracted source term.

3. Automatic Placement of Non-Textual Inline Element Placeholders in a Target Segment

The automatic inline transferer is a mechanism that handles the transfer of elements identified as inlines (e.g. HTML tags) from a source sentence to a translated target sentence.

The goal of the inline transferer mechanism is to fully automatically transfer the inlines from the source sentence to the translated target sentence at correct positions. Thus, the translator only concentrates on translating the meaningful content of the text. The inline transferer relieves the translator of the technical and time-consuming process of copying non-translatable elements from the source sentence to the translation. To make it possible, the Inter-Language Vector Space is used to identify the corresponding words in the source and target sentences.

4. Automatic Assessment of Machine Translation Quality

By providing similarity measures for words in different languages, the Inter-Language Vector Space can be used to develop a measure for inter-language sentence similarity. This in turn can be used to compare the output of machine translation to the original source. Low similarity measure would indicate unsatisfactory performance of the machine translator, whereas high similarity—high quality of the translation.

5. Automatic Assessment of Human Translation Quality

The technique described in point 4 can also be used to assess the quality of human translation, especially to detect segments with very low translation quality.

6. Highlighting Potential Translation Errors

The Inter-Language Vector Space can be used to highlight words in the source sentence which do not have similar counterparts in the translation. This situation is a potential translation error. The technique of highlighting such errors allows for aiding the review of the translation.

7. Automatically Providing Completion for Fuzzy Matched Segments

Upon querying the translation memory, a translator receives a list of segments similar but not identical to the segment he/she is currently translating. These similar segments are referred to as fuzzy matched segments. The Inter-Language Vector Space can detect the differences between the translated segment and those fuzzy matched segments and provide operations necessary for their adjustment to produce the final translation.

8. Target Segment Sub-Segment Matching

While producing translation in the target segment, the translator can look up sub-segment phrases from the translation memory that could serve as suggestions for translation. The Inter-Language Vector Space could score those phrases according to the similarity with the source sentence. The highest scored and most helpful suggestions would then appear first on the suggestions list.

9. Syntactic Analysis of Source and Target Translation

By providing similarity scores for every word pair from the source and target segment, the Inter-Language Vector Space can be used to identify syntactic chunks and their counterparts in the translation. This is based on the fact that contextual similarity captured by the Inter-Language Vector Space is known to model syntactic relationships between words.

10. Semantic Analysis of Source and Target Translations

Since contextual similarity captured by the Inter-Language Vector Space also models semantic relationships between words, it is also possible to perform semantic analysis of the source and target translation with the use of the technique described in point 10.

11. Identify Similar Documents in Different Languages According to their Content

Thanks to the robustness of the Inter-Language Vector Space, word similarities can be effectively computed for a large number of word pairs. For that reason, it is possible to compute similarities between all words in two documents. If the aggregated similarity scores are high, the two documents can be considered similar, even though written in different languages.

12. Identify Synonyms Across Languages

The Inter-Language Vector Space captures the similarity between words and their synonyms (as being similar to the original word). It is therefore possible to identify synsets in one language and their corresponding synsets in another language.

13. Produce a List of Possible Translations for a Given Word in Language a in Language B

By examining the similarity scores returned by the Inter-Language Vector Space for a word in one language and all words in another language it is possible to create a list of possible translations of this word.

14. Assist the Translator in Providing Possible Translations for a Given Word

The technique described in point 14 can be used to assist translators in their work by suggesting possible translations for a given word.

15. Predictive Typing

The technique described in point 14 can be implemented to provide the suggestions on the fly (while typing the translation).

16. Automatic Language Detection

Automatic language detection is a technique of predicting the language of a longer text (at least one paragraph) using automatic methods. By providing individual vector spaces for each language, the Inter-Language Vector Space enables comparing words from the input text to every supported vector space. The language of the vector space containing the most similar words to those from the input text would be chosen as the predicted language of the input text.

17. Automatic Correction of Misspelled Words

With the ability of generating contextually similar words, the Inter-Language Vector Space can provide suggestions for correction of misspelled words, e.g. typos or OCR errors.

18. Word Sense Disambiguation

Words in natural languages can typically have multiple meanings. In a situation where the translation of an analyzed text is available the Inter-Language Vector Space can be used to identify the translation of an ambiguous word. This translation can then be used to disambiguate the word.

19. Inter-Language Plagiarism Detection

The technique described in point 12—identification of similar documents across languages—can be used to detect plagiarisms created by direct translation of a reference text. This can be used to effectively detect even small portions of plagiarisms of a longer reference text.

20. Learn a Given Pattern for Machine Translation Post-Edit Correction

To learn a given pattern for machine translation post-edit correction and automatically apply the same pattern for following/future segment

21. Assist in the Creation of a Dynamic Learning Algorithm that Learns from a Translation

To learn from a human translator as he translates sentence by sentence and apply the learned information to future sentences to provide a target language translation of the sentence.

### DETAILS ON HOW IT IS/WAS MADE

Inter-Language Vector Space was constructed with the following operations: training of word embeddings for each supported language [FIG. 1], alignment of vector spaces [FIG. 2], transformation of vectors and indexing of the vector dictionaries [FIG. 3].

Training of Word Embeddings

The process of training word embeddings is aimed at converting words found in text into their vector representations. Each word is represented by a single 300-dimensional vector of real numbers from the range [−1, 1]. In order to obtain these representations a shallow 2-layer feed forward neural network is used. Its training objective is the skip-gram model—the network is given a task of predicting words surrounding the input word. In order to do that the network is presented with large-scale text corpus which contains an abundance of exemplary contexts for each distinct word. In our implementation the corpus was extracted from a crawl of the whole explorable Internet, separately for each language.

When the training of the neural network is finished, the network is capable of predicting the context of a given input word according to the skip-gram model. In its hidden layer it uses representation of the input word on multiple neurons. This representation is used to construct the vector representation of the word within the language. [FIG. 1]

This vector representation allows for assessing similarity of words within one language. Calculated cosine similarity between vectors for semantically similar words (such as “street” and “road”) yields high similarity scores. On the other hand, cosine similarity calculated on vectors for distant words (such as “table” and “sun”) yields low values. This technique therefore models the concept of contextual similarity of words using their vector representation and mathematical vector similarity measures.

The result of this stage are dictionaries mapping distinct words into their 300-dimensional vector representations, one dictionary per language.

Alignment of Vector Spaces

The vector representation of words obtained in the previous step serves for calculation of similarity in only one language. Our solution however allows for assessing word similarities across languages. To make it possible, the vector spaces for individual languages are aligned. Without this step, the vector for the word “cat” in the English vector space does not exhibit any similarity to the vector for the word “chat” in the French vector space. This is due to the fact that English and French vector spaces were created in separate training processes using different texts from which the information about correspondence of the English word “cat” to French “chat” could not be inferred.

The aim of the operation of aligning of the vector spaces is to enable the comparison of similar words across languages. After this operation the vector for the English word “cat” is similar (with respect to cosine similarity) to the French vector for “chat”, Spanish vector for “gato”, Russian vector for “kowka” etc.

In order to align vector space for the language A to the vector space for the language B, the following procedure is executed. First, a transformation matrix is calculated according to the Singular Value Decomposition algorithm. An input for this method is a list of pairs (a,b), where a E A and b E B. Points a and b effectively represent words in language A and B respectively. It is important that the pairs (a,b) represent words that correspond to each other, i.e. their expected inter-language similarity is high. In order to identify such pairs, a list of homographs found in languages A and B is used. These homographs typically include proper names, such as “London” or “Paris”. Before alignment of the vector spaces, the cosine similarity between the vectors for the word “London” in vector spaces A and B is typically low. It is expected to raise after the vector spaces alignment is finished. The SVD learns to convert the vector for the word “London” (and all other examples) so they resemble their respective equivalents in the target vector space. In order to enhance the quality of this training, the list of homographs is enriched with a list of word equivalents from a digital bilingual dictionary for the language direction A-B. Note that this step is crucial in ensuring high performance of the Inter-Language Vector Space.

The SVD method is used to compute a 300×300 transformation matrix with the following inputs:
list of pairs (a,b)
vectors in the vector space A
vectors in the vector space B

The matrix is used to align vector spaces A and B by providing a transformation to apply on vectors in A to make them comparable with vectors in B. Although the transformation is trained on the homographs and words appearing in the bilingual dictionary, it can be applied to any word in the source language to make it comparable with target vectors. For that reason, the Inter-Language Vector Space is capable of assessing the probability of translation of two words even in the situation when none of the words was found in a dictionary, i.e. for words that have never been appointed as translations by human translators. [FIG. 2.]

The Inter-Language Vector Space currently supports 250 languages. This is to say that word vectors in any two of the supported languages can be compared to each other. Theoretically, this would require performing vector space alignment for all 31125 language pairs which can be composed using the set of 250 languages. Because the step of aligning the vector spaces using SVD takes about 10-15 minutes on a high-performance server machine, alignment in all these directions would be impractical. Hence, the following approach is assumed: the vector space for English becomes the central, reference vector space. Vector spaces for all other languages are aligned to English. Therefore, adding support for a single new language to the Inter-Language Vector Space allows to compare vectors in this language to any of the languages previously supported. All vectors are compared in the English vector space.

Experiments in several language pairs (e.g. French and Turkish) have proven that the approach of aligning separately French to English and Turkish to English performs even better than aligning French to Turkish directly. This is due to the fact that English vector space was trained on the largest resources and therefore is the richest linguistically.

Transformation and Indexing of the Vector Dictionaries

The last step in the Inter-Language Vector Space creation process is the transformation of the vectors using transformation matrices obtained in the previous step. Since the vectors in all vector spaces are 300-dimensional, they can be viewed as matrices of the size [1×300]. They are then multiplied by an appropriate transformation matrix, e.g. French vectors are multiplied by the [300×300] French to English transformation matrix. As a result, a new [300×1] matrix is computed which is viewed as the transformed 300-dimensional vector.

The operation of vector transformation is performed on every word in the vector dictionary in a single vector space. This creates a new vector dictionary aligned to the English vector space. This dictionary is then indexed with the use of a disk based index software.

When calculating the similarity between two words in any of the supported languages, the disk based vector dictionaries are first queried to obtain the vectors for these languages. Then, thanks to the fact that the vector spaces for these vectors were previously aligned, the computed cosine similarity of the obtained vectors reflects the inter-language similarity of the words. [FIG. 3]

What it Encompasses

Inter-Language Vector Space encompasses the normalization of the Vector Spaces of two languages onto the same representational normalized set of values in order to provide the probability value that a given word in the source language is a translation of a given word in the target language. Due to the underlying semantics of the Vector Spaces of the two languages it can provide this even if no prior translation of the word ever existed, e.g in the case of the use synonyms etc. in the source language and target language: e.g if say ‘wild’ was used in the target language for ‘savage’ in the source language.

A detailed drawing which shows and explains the invention

1. A method of normalizing the Vector Spaces of two languages onto the same representational normalized set of values in order to provide the probability value that a given word in the source language is a translation of a given word in the target language.

2. The method of claim 1, providing a method for bilingual corpus alignment

3. The method of claim 1, providing a method for bilingual terminology extraction

4. The method of claim 1, providing a method for the automatic placement of non-textual inline element placeholders in a target segment

5. The method of claim 1, providing a method for the automatic assessment of machine translation output

6. The method of claim 1, providing a method for the automatic assessment of human translation quality

7. The method of claim 1, providing a method for highlighting potential translation errors

8. The method of claim 1, providing a method for automatically providing completion for fuzzy matched segments

9. The method of claim 1, providing a method for automatically providing target segment sub-segment matching

10. The method of claim 1, providing a method for automatically providing syntactic analysis of source and target translation

11. The method of claim 1, providing a method for automatically providing a semantic analysis of source and target translations

12. The method of claim 1, providing a method for automatically providing a method to Identify similar documents in different languages according to their content

13. The method of claim 1, providing a method for automatically providing a method to Identify similar documents in different languages according to their content

14. The method of claim 1, providing a method for automatically providing a method to Identify synonyms across languages

15. The method of claim 1, providing a method for automatically providing a method to Produce a list of possible translations for a given word in language A in language B

16. The method of claim 1, providing a method for automatically providing a method to Assist the translator in providing possible translations for a given word

17. The method of claim 1, providing a method for automatically providing a method to provide predictive typing for a translator

18. The method of claim 1, providing a method for automatically providing a method to provide automatic language detection

19. The method of claim 1, providing a method for automatically providing a method to provide automatic correction of misspelled words

20. The method of claim 1, providing a method for automatically providing a method to provide word sense disambiguation

21. The method of claim 1, providing a method for automatically providing a method to provide inter-language plagiarism detection

22. The method of claim 1, providing a method for automatically providing a method to learn a given pattern for machine translation post-edit correction and automatically apply the same pattern for following/future segment

23. The method of claim 1, providing a method for automatically providing a method to assist in the creation of a dynamic learning algorithm that learns from a translation
